(19) United States
(12) Patent Application Publication
(10) Pub. No.: US 2008/0259722 A1
(43) Pub. Date: Oct. 23, 2008

(54) Blender for production of scented materials

(76) Inventor: SAMUEL A. SANFORD, Bend, OR (US)

Correspondence Address: LITMAN LAW OFFICES, LTD., P.O. BOX 15035, CRYSTAL CITY STATION, ARLINGTON, VA, 22215-0035, US

(21) Appl. No.: 12/076,750

(22) Filed: Mar. 21, 2008

Related U.S. Application Data
(60) Provisional application No. 60/907,928, filed on Apr. 23, 2007.

(51) Int. Cl. B01F 7/00

(52) U.S. Cl. 366/205

(57) ABSTRACT

The blender for production of scented materials has mutually connecting containers or chambers that attach to a conventional motorized blender base. The chambers include a mixing chamber having a removable blade assembly and base attachment mount, a filtration chamber installed upon the mixing chamber, and a collection chamber installed upon the filtration chamber. The filtration chamber may include one or more scent absorbent pads removably installed in the neck thereof. The blender is used by assembling the mixing chamber upon the blender base, adding ingredients and liquid, installing the filtration and collection chambers, and operating the blender. When the ingredients have been mixed and comminuted, the chamber assembly is removed from the base and inverted to drain the liquid mixture through the scent absorbent discs and into the collection bottle. The discs and collection bottle are then removed for use in distributing the scent.

### CROSS-REFERENCE TO RELATED APPLICATION

This application claims the benefit of U.S. Provisional Patent Application Ser. No. 60/907,928, filed Apr. 23, 2007.

### BACKGROUND OF THE INVENTION

1. Field of the Invention

The present invention relates generally to devices for mixing and blending materials. More specifically, the present invention relates to a blender for production of scented materials that may be used to mask other scents or to create attractive scents for game in hunting, or for other purposes.

2. Description of the Related Art

Various scents have long been known to attract game when hunting, and even where such scents may be prohibited, it is still desirable to mask the human scent of the hunter and his or her equipment. Anglers have long known of the scents produced by various materials, e.g., chopped bait, and even some cheeses, etc., for attracting fish. More generally, various air fresheners have been developed, with most such air fresheners having an attractive scent for placement in the home, automobile, etc.

Many, if not most, of the above scents have been made available commercially, and other than in fishing, it has been difficult for a person desiring to make use of a certain scent to produce that scent at home. While blenders and other mixing devices are well known, such devices produce scents only as a secondary effect, and are not configured for producing an end product that is primarily intended to produce a scent for use in hunting, fishing, or other purposes.

An example of a grinding device is found in German Patent No. 4,025,995, published on Jun. 27, 1991. According to the drawings and English abstract, the apparatus comprises two grinders capable of grinding to different granule sizes, and a system for returning larger granules back to the first grinder for regrinding or to the second grinder for finer grinding. The device is primarily intended for grinding coffee.

Thus a blender for production of scented materials solving the aforementioned problems is desired.

### SUMMARY OF THE INVENTION

The blender for production of scented materials has a series of stages or sections installed upon a motorized base for operation. The first or lowermost section is a mixing or blending chamber, with the chopping blades of the motorized base extending upwardly into this chamber. A filtration chamber is removably attached atop the mixing chamber, serving to prevent the entrance of relatively large particles into the final collection container. A series of scent absorbent pads or discs may be placed in the upper end of the filtration chamber, with the processed liquid passing through the scent pads en route to the uppermost collection bottle or container. An additional final filter may be placed between the scent pads and the collection bottle or container, if desired.

The device is used by placing scent-producing materials (e.g., grasses, pine needles, soil, etc.) in the lower or mixing chamber, along with a liquid (water, non-scented gel, etc.) to serve as a carrier or vehicle for the scent. If the production of scent-impregnated pads is desired, such pads may be installed within the upper end of the filtration chamber before the operation. The assembly is closed with a collection bottle or container at the uppermost end, and the motorized blending or mixing blades are activated. When the desired mixing and blending has been accomplished, the apparatus is inverted to drain the liquid through the filter, through the scent absorbent pads, and into the collection container, which is now positioned beneath the remainder of the apparatus. When essentially all of the liquid has drained into the collection bottle, the bottle may be removed and capped, and the scent-impregnated pads may be removed and sealed for future use.

These and other features of the present invention will become readily apparent upon further review of the following specification and drawings.

### BRIEF DESCRIPTION OF THE DRAWINGS

FIG. 1 is a perspective view of a blender for production of scented materials according to the present invention, including a motorized base and chamber assembly thereon.

FIG. 2 is an exploded perspective view of the base attachment and chamber assembly of a blender for production of scented materials according to the present invention.

FIG. 3 is an exploded perspective view of a blender for production of scented materials according to the present invention, showing the mixing chamber attached to the motorized base with the filtration and collection chambers removed therefrom, and with ingredients being added to the mixing chamber.

FIG. 4 is an exploded perspective view of a blender for production of scented materials according to the present invention with the base attachment and chamber assembly removed and inverted relative to the motorized base, showing disassembly of the components after blending for removal of scented materials therefrom.

Similar reference characters denote corresponding features consistently throughout the attached drawings.

### DETAILED DESCRIPTION OF THE PREFERRED EMBODIMENTS

The present invention is a blender apparatus or assembly for producing scented materials, for use in making scents for use in hunting, fishing, home or automotive interior air freshening, or other purposes. The apparatus may use a conventional motorized blender base or other means for driving the mixing blades within the lower chamber of the device.

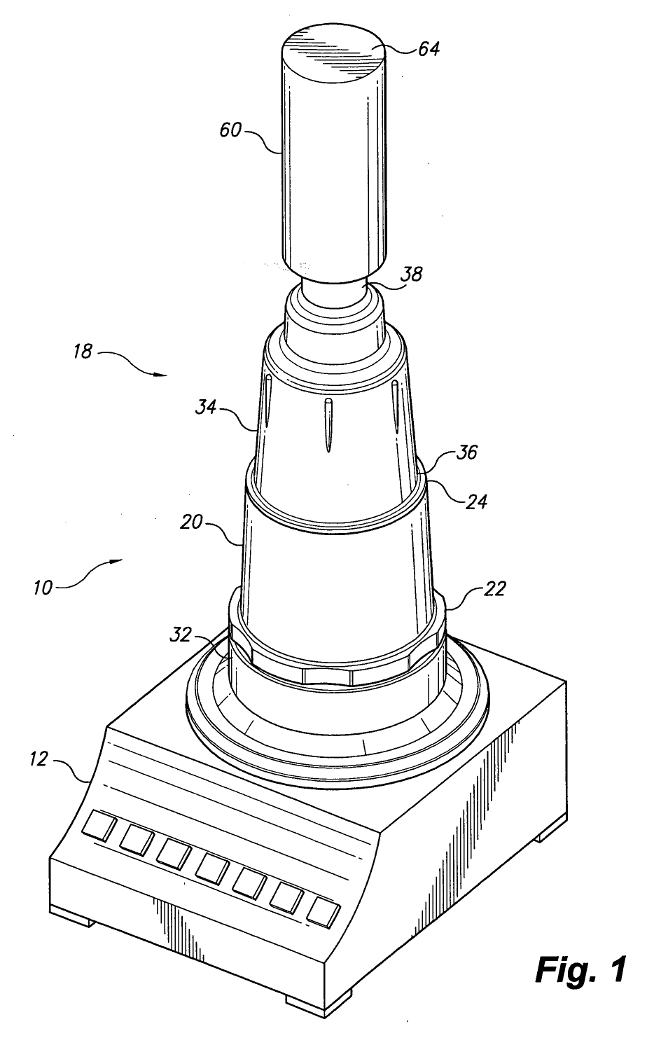

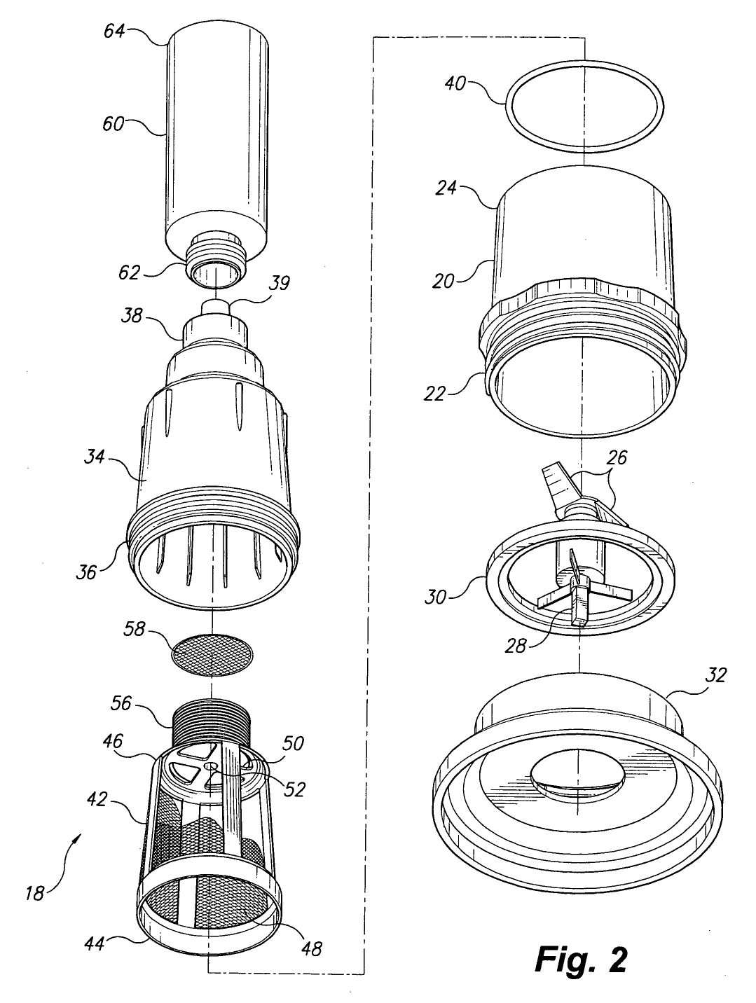

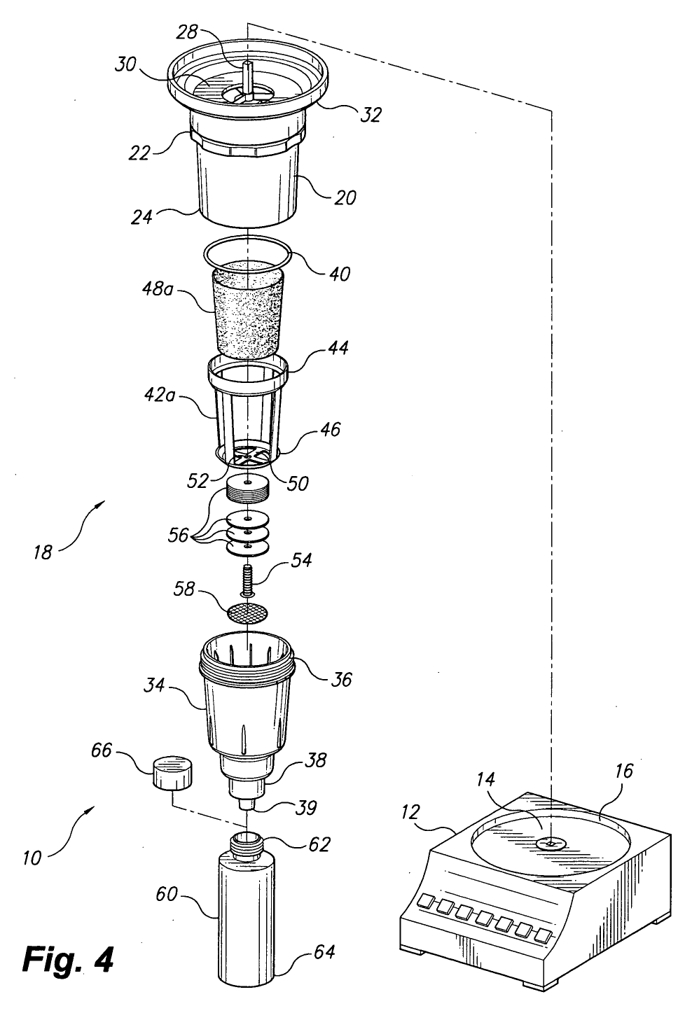

FIG. 1 of the drawings provides a perspective view of the entire blender apparatus 10 for producing scented materials, with FIG. 2 providing an exploded perspective view of the various components. A conventional motorized blender base 12 is illustrated in FIGS. 1, 3, and 4, but other blade driver means may be used in lieu thereof, as noted above. The blender base 12 includes a conventional mixing blade drive 14 and mixing chamber mount 16 thereon, generally as shown in FIG. 4 of the drawings. Other types of blender bases may be used, with the lowermost portion of the container assembly being modified as required to fit any practicable blender configuration.

A blending chamber assembly 18 is removably installed atop the blender base 12, with the blending chamber including a series of separable components. The first of these components, i.e., the component that attaches to the blender base 12, is a mixing chamber 20. The mixing chamber 20 includes a first or lowermost end 22 when the chamber 20 is secured to the blender base 12, and an opposite second end 24. The first end 22 further includes a conventional mixing blade or blades 26 extending from a shaft 28, which passes through a conventional passage and seal formed concentrically through a bottom closure 30, as shown in FIG. 2. The bottom closure 30 is removably sealed to the first end 22 of the mixing chamber 20 by an adaptor 32, with the blade drive shaft 28 engaging the mixing blade drive 14 of the motorized base 12 in a manner known in the art of household blenders and the like.

A filtration chamber 34 includes a first end 36 which removably seals to the second end 24 of the mixing chamber 20, and a second end 38 opposite its first end. An O-ring 40 or other suitable seal may be installed between the two chambers 20 and 34. The filtration chamber 34 includes a removable filter holder 42 having a filter element disposed integrally therewith. The filter holder 42 comprises a frame having generally open sides, an open first end 44, and an opposite open second end 46, and serves as a holder for the filter element 48 therein, with the filter element 48 being shown partially in FIG. 2 in order to show details of the filter holder frame 42. The filter element 48 is preferably a washable and reusable unit of fine mesh screen (metal, plastic fiber, etc.) constructed and assembled integrally with the removable filter holder 42, as shown in FIG. 2. Alternatively, a filter frame 42a for the carriage of a separable and disposable element 48a of paper or other material may be provided, as shown in FIG. 4. The filter holder 42 (or 42a) is configured to fit closely within the interior of the filtration chamber 34, with the first and second ends 44 and 46 of the filter holder 42 (or 42a) disposed closely adjacent to the corresponding first and second ends 36 and 38 of the filtration chamber 34 when installed therein.

The blender 10 for producing scented materials is capable of producing scented pads for various purposes (masking of foreign scents for hunting, fish attractant scents, home air fresheners, etc.). The second end 46 of the filter holder 42 (or 42a) includes a scent pad attachment frame 50 extending thereacross, with the pad attachment frame 50 including a scent pad attachment passage 52 disposed concentrically therethrough. A scent pad holding pin 54 (shown in FIG. 4) is removably secured within the scent pad attachment passage or hole 52 and serves to capture one or more (preferably a plurality of) scent absorption pads 56 thereon. Each of the pads 56 is configured to fit closely within the interior of the filtration chamber 34 adjacent the second end 38 thereof, and includes a central hole formed therethrough for insertion of the holding pin 54. The holding pin 54 is secured in the attachment passage 52 of the scent pad attachment frame 50 of the filter holder 42 or 42a, e.g., by means of a conventional partial turn “bayonet” type attachment, flexible flanges extending radially from the pin 54 to grip the opposite side of the attachment passage 52, threaded attachment, etc., as desired.

A catch screen 58 (shown in FIGS. 2 and 4) may be removably installed within the second end 38 of the filtration chamber 34 beyond the scent absorbent pads 56, if desired. The screen 58 is preferably formed of a wire mesh material, and is of a coarser gauge or mesh than the filter element 48 or 48a. This screen 58 serves to capture any relatively large particles of material that may happen to flow past the outer surface of the filter element 48 or 48a between the filter element 48 or 48a and the wall of the filtration chamber 34 during use. The screen 58 is preferably of a reusable material, and may be removed and cleaned between uses of the scent manufacturing blender assembly 10.

Finally, a collection chamber or bottle 60 is removably attached to the filtration chamber 34. The collection chamber 60 includes a first end 62, which seals to the second end 38 of the filtration chamber 34 when attached thereto, and a permanently closed and sealed second end 64. The first end 62 of the collection chamber 60 comprises an externally threaded neck configured for attachment to the cooperating internally threaded second end 38 of the filtration chamber 34. The second end or neck 38 of the filtration chamber 34 includes an extension spout 39 disposed concentrically therein, with the extension spout 39 extending beyond the internally threaded second end or neck 38 of the filtration chamber 34.

This extension spout 39 extends into the interior of the externally threaded neck of the collection chamber 60 when the filtration chamber 34 and collection chamber 60 are threadably assembled to one another, and precludes spillage of material from the filtration chamber 34 around the exterior of the collection chamber 60 when the filtration chamber 34 is removed from the underlying collection chamber 60 after scent production operations. The blending chamber assembly 18, including the mixing chamber 20, filtration chamber 34, and collection chamber 60, form a closed container when assembled together, with the interior volumes of each of the chambers communicating with one another and allowing the flow of materials therethrough, subject to any internal filtration described further above.

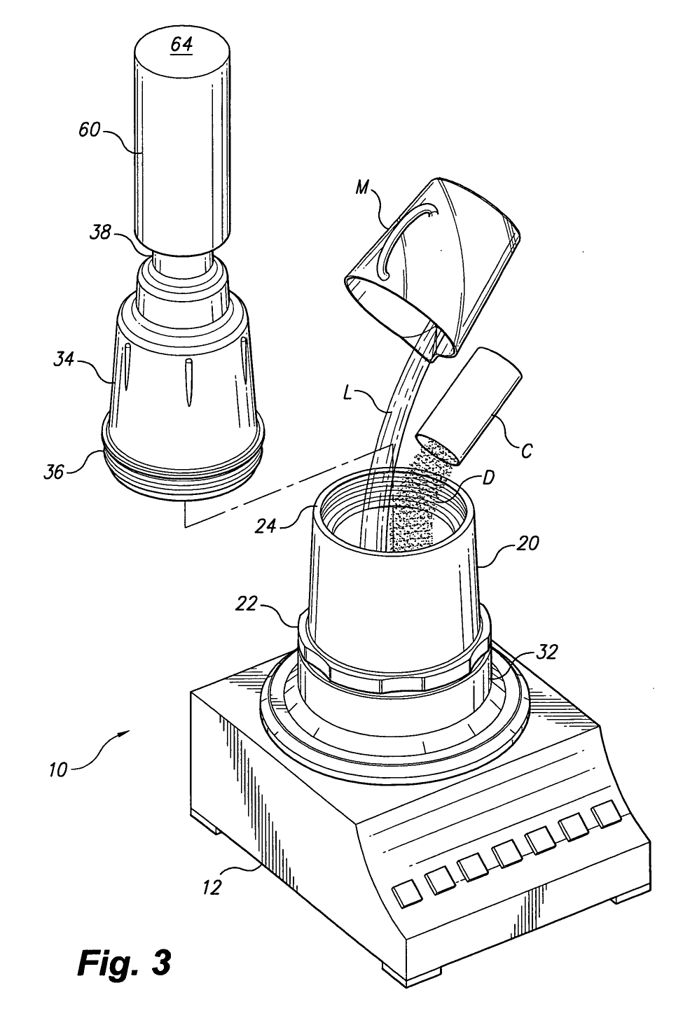

FIGS. 3 and 4 illustrate the general procedure for producing or manufacturing scented liquids or pads using the blender 10. Initially, the mixing chamber 20 with its mixing blade assembly 26, mixing chamber bottom closure or cover 30, and adapter 32 are installed upon the motorized blender base 12, leaving the upper second end 24 of the mixing chamber 20 open. If the production of one or more scented pads 56 is desired, the pads are secured to the attachment frame 50 of the filter holder frame 42, using the pad attachment pin 54, at this time. The screen 58 (if used) is placed within (or adjacent to) the second end 38 of the filter chamber 34, and the filter holder 42 or 42a and clean filter element 48 or 48a are installed within the filter chamber 34.

At this point, the materials to be used to produce the desired scent may be added to the mixing chamber 20 through the open upper or second end 24 thereof, generally as shown in FIG. 3 of the drawings. These materials may comprise myriad dry or liquid materials, e.g., assorted grasses, leaves, mosses, earth or soil, etc., which may produce the desired scent when mixed. The various liquids may comprise unscented gel, water from a certain locale, animal urine, etc. as desired. In FIG. 3, a quantity of dry material D is being poured into the mixing chamber 20 from a suitable container C, with an appropriate quantity of liquid ingredient L being poured from a measuring cup M (or other suitable container). Other ingredients, e.g., baitfish, fish oils and extracts, certain pungent cheeses, etc. may be used to produce scents that are attractive to fish, if desired. Alternatively, the blender 10 may be used to produce scents and aromas that are pleasing to people, e.g., floral scents, various food scents, etc., as desired. The various materials described herein are intended to be exemplary, and by no means limit the ingredients that may be used with the blender 10.

Once the appropriate or desired ingredients have been added to the mixing chamber 20, the filtration chamber 34 (with its previously installed filter holder 42 or 42a and filter element 48 or 48a, scent pads 56, and/or final filtration screen 58) is secured to the upper or second end 24 of the mixing chamber 20. The collection chamber 60 may then be secured atop the second end 38 of the filtration chamber 34 to close the container assembly, if this step has not previously been carried out. The blender 10 is now ready for operation, and will have the general appearance of the assembly 10 of FIG. 1 of the drawings.

The blender motor in the base 12 is now operated for a predetermined time, with the blades 26 within the lower portion of the mixing chamber 20 chopping, cutting, and comminuting the scent producing materials and mixing them with the liquid added to the chamber 20, as is conventional in such blender devices. Once the desired degree of mixing and blending has been accomplished, the entire chamber assembly 18 may be removed from the motorized base 12 by detaching the adapter 32 from the mounting structure 16 of the base 12, and/or removing the adapter 32 from the first end 22 of the mixing chamber 20. It may be necessary to retain the adapter 32 on the mixing chamber 20 in order to retain the seal of the bottom closure 30 with the mixing chamber 20, depending upon the specific configuration of the blender base 12, blade assembly 26, and closure 30 and their fit with the first end 22 of the mixing chamber 20. In any event, it will be seen that the assembly 18 may be removed from the blender base 12 without the loss or spillage of liquids or materials within the container assembly 18, so long as the first end 22 of the mixing chamber 20 remains closed.

At this time the entire container assembly 18 is inverted, with the various liquid and solid materials forming the scent mix draining into the filtration chamber 34. The assembly 18 will have the orientation shown in FIG. 4 relative to the motorized base 12, but will still be in an assembled state, as shown in the assembly 18 of FIG. 1. The mixed scent materials pass through the filter element 48 or 48a, which filters out all but the finest particulate matter. The remaining scented liquid then passes through the scent absorption pads 56, if installed, and finally through the screen 58, which catches any relatively large particulate matter that may have bypassed the filter element 48, to drain into the collection container 60.

When essentially all of the liquid within the container assembly 18 has drained into the collection container 60 (excepting that which has saturated the filter 48 or 48a and scent absorption pads 56), the collection chamber or container 60 may be removed from its attachment to the second end 38 of the filtration chamber 34. The extension spout 39 extends downwardly into the neck of the collection container 60 during this operation, precluding liquids running down the internal threads of the second end or neck 38 of the filtration chamber 34 and down the outside of the external threads 62 and outer surface of the collection container 60. An internally threaded cap 66 is secured to the collection container or bottle 60 to seal the scented liquid therein for future use. The remainder of the container assembly 18 may then be disassembled for cleaning, with the reusable filter element 48 of the filter frame 42 of FIG. 2 being cleaned for reuse or the disposable filter element 48a of FIG. 4 being discarded, and the scent absorption pads 56 being placed in a suitable sealed container for future use.

In conclusion, the blender for the production of scented materials enables the hunter, angler, homemaker, and other parties desiring to produce a specific odor or aroma for a specific purpose to do so without need to purchase various scents that may or may not be suitable or precisely what is desired. The blender is particularly valuable for hunters and anglers, enabling them to produce a specific scent to attract game or fish, and can provide a scent that may not be available at all commercially. Accordingly, the blender for the production of scented materials will prove extremely popular with hunters, anglers, nature photographers who wish to attract animals for photography, and all others who have need or desire to produce specific scents from raw materials.

It is to be understood that the present invention is not limited to the embodiments described above, but encompasses any and all embodiments within the scope of the following claims.

I claim:

1. A blender for production of scented materials, comprising:
a motorized blender base having a mixing blade drive and a mixing chamber mount thereon;
a mixing chamber removably disposed atop the blender base, the mixing chamber having a first end and a second end opposite the first end;
a mixing blade removably attached and sealed to the first end of the mixing chamber, the mixing blade engaging the mixing blade drive of the blender base when the mixing chamber is installed on the blender base;
a filtration chamber having a first end and a second end opposite the first end, the first end being removably attached and sealed to the second end of the mixing chamber; and
a collection chamber having a first end and a closed second end opposite the first end, the first end being removably attached and sealed to the second end of the filtration chamber.

2. The blender for production of scented materials according to claim 1, further comprising at least one scent absorption pad removably disposed within the second end of the filtration chamber.

3. The blender for production of scented materials according to claim 1, further comprising:
a filter holder frame removably installed within the filtration chamber, the filter holder frame having a first end and a second end opposite the first end, the first end and the second end of the filter holder frame being disposed adjacent the corresponding first end and second end of the filtration chamber when installed therein; and
a filter element disposed within the filter holder frame.

4. The blender for production of scented materials according to claim 3, further comprising:
a scent pad attachment frame disposed across the second end of the filter holder frame, the scent pad attachment frame having a scent pad attachment passage disposed concentrically therethrough;
a scent pad holding pin removably secured within the scent pad attachment passage; and
at least one scent absorption pad selectively secured to the scent pad attachment frame by the scent pad holding pin.

5. The blender for production of scented materials according to claim 1, further comprising a filter screen removably installed within the second end of the filtration chamber.

6. The blender for production of scented materials according to claim 1, wherein said collection chamber has an externally threaded neck extending from the first end thereof, the blender further comprising:
an internally threaded cap removably and cooperatively secured to the neck of said collection chamber; and
an extension spout disposed concentrically within the neck of said filtration chamber and extending therebeyond, the extension spout being inserted into the externally threaded neck of said collection chamber when said collection chamber and said filtration chamber are threadably assembled together.

7. A method of producing scented materials using the apparatus of claim 1, comprising the steps of:
(a) removably attaching the mixing chamber to the motorized blender base;
(b) adding scent producing materials and liquid;
(c) removably attaching the filtration chamber to the mixing chamber;
(d) removably attaching the collection chamber to the filtration chamber;
(e) operating the blender base to produce a scented liquid;
(f) removing the mixing chamber, filtration chamber, and collection chamber from the blender base, as a closed assembly;
(g) inverting the mixing chamber, filtration chamber, and collection chamber, thereby draining the scented liquid into the collection chamber; and
(h) removing the collection chamber from the filtration chamber.

8. A blender for production of scented materials, comprising:
a motorized blender base having a mixing blade drive and a blending chamber mount thereon;
a blending chamber removably disposed atop the blender base, the blending chamber having a first end;
a mixing blade removably attached and sealed to the first end of the blending chamber, the mixing blade engaging the mixing blade drive of the blender base when the blending chamber is installed on the blender base; and
at least one scent absorption pad removably disposed within the blending chamber.

9. The blender according to claim 8, wherein the blending chamber further comprises:
a mixing chamber removably disposed atop the blender base, the mixing chamber having a first end and a second end opposite the first end, the first end having a mixing blade removably attached and sealed thereto, the blade engaging the mixing blade drive of the blender base when installed thereon;
a filtration chamber having a first end and a second end opposite the first end, the first end of the filtration chamber being removably attached and sealed to the second end of the mixing chamber; and
a collection chamber having a first end and a closed second end opposite the first end, the first end of the collection chamber being removably attached and sealed to the second end of the filtration chamber.

10. The blender for production of scented materials according to claim 9, further comprising:
a filter holder frame removably installed within the filtration chamber, the filter holder frame having a first end and a second end opposite the first end, the first end and the second end of the filter holder frame being disposed adjacent the corresponding first end and second end of the filtration chamber when installed therein; and
a filter element disposed within the filter holder frame.

11. The blender for production of scented materials according to claim 9, wherein the at least one scent absorption pad is removably disposed within the second end of the filtration chamber.

12. The blender for production of scented materials according to claim 11, further comprising:
a scent pad attachment frame disposed across the second end of the filter holder frame, the scent pad attachment frame having a scent pad attachment passage disposed concentrically therethrough;
a scent pad holding pin removably secured within the scent pad attachment passage, the at least one scent absorption pad being selectively secured to the scent pad attachment frame by the scent pad holding pin.

13. The blender for production of scented materials according to claim 9, further comprising a filter screen removably installed within the second end of the filtration chamber.

14. The blender for production of scented materials according to claim 9, wherein said collection chamber has an externally threaded neck extending from the first end of thereof, the blender further comprising:
an internally threaded cap removably secured to the neck of said collection chamber; and
an extension spout disposed concentrically within the neck of the filtration chamber and extending therebeyond, the extension spout being inserted into the externally threaded neck of said collection chamber when said collection chamber and the filtration chamber are threadably assembled together.

15. A method of producing scented materials, comprising the steps of:
(a) removably attaching a mixing chamber to a motorized blender base;
(b) adding scent producing materials and liquid to the mixing chamber;
(c) removably attaching a filtration chamber to the mixing chamber;
(d) removably attaching a collection chamber to the filtration chamber;
(e) operating the blender base to produce a scented liquid;
(f) removing the mixing chamber, the filtration chamber, and the collection chamber from the blender base as a closed assembly;
(g) inverting the mixing chamber, filtration chamber, and collection chamber, thereby draining the scented liquid into the collection chamber; and
(h) removing the collection chamber from the filtration chamber.

16. The method of producing scented materials according to claim 15, further comprising the steps of:
removably installing a filter holder frame within the filtration chamber, the filter holder frame having a first end and a second end opposite the first end; and
removably installing a filter element within the filter holder frame.

17. The method of producing scented materials according to claim 16, further comprising the steps of:
providing a scent pad attachment frame across the second end of the filter holder frame, the scent pad attachment frame having a scent pad attachment passage disposed concentrically therethrough;
(b) removably inserting a scent pad holding pin through at least one scent pad; and
(c) removably securing the scent pad holding pin within the scent pad attachment passage, thereby securing the at least one scent absorption pad to the scent pad attachment frame.

18. The method of producing scented materials according to claim 15, further comprising the step of removably installing at least one scent absorption pad within the filtration chamber adjacent the collection chamber.

19. The method of producing scented materials according claim 15, further comprising the step of removably installing a filter screen within the second end of the filtration chamber.

20. The method of producing scented materials according to claim 15, further comprising the step of removably securing an internally threaded cap to the collection chamber.
